(19) United States
(12) Patent Application Publication
(10) Pub. No.: US 2010/0031801 A1
(43) Pub. Date: Feb. 11, 2010

(54) MUTE FOR A RECORDER

(75) Inventor: Renato Montemurro, Mese (IT)

Correspondence Address: VENABLE LLP, P.O. BOX 34385, WASHINGTON, DC, 20043-9998, US

(73) Assignee: Bonini S.R.L., Delebio (IT)

(21) Appl. No.: 12/161,464

(22) PCT Filed: Jan. 19, 2007
(86) PCT No.: PCT/EP07/50526

§ 371 Date: Feb. 19, 2009

(30) Foreign Application Priority Data
Jan. 20, 2006 (IT) LC2006A 000001

(51) Int. Cl. G10D 9/06

(52) U.S. Cl. 84/400

(57) ABSTRACT

A mute, appropriately conceived for a recorder, is capable of softening the sonority of the recorder which is provided with a window partially delimited by a sharp edge (S) suitable to create air vortexes when invested by blown air; the mute being provided with a flow barrier inserted through the window so as to partially deviate the blown air flowing towards the sharp edge (S).

### TECHNICAL FIELD

The present invention relates to a mute for a recorder, in particular for a treble recorder.

### BACKGROUND ART

Many wind instruments, as e.g. the trumpet, normally have a mute which can be employed to play jazz music or to soften the strong sonority during practice times.

The recorder, and in particular the treble recorder, is widely used in the schools during compulsory education.

The recorder is characterised by high-pitched or very high-pitched tones that could render it very distressing.

It must also be taken in consideration that some notes of the second octave can be only obtained by hard blowing thus forcing to emit high-pitched and concurrently loud sounds.

Considering the above-indicated operating conditions, in addition to the unavoidable mistakes during practice, the practice of youngsters inevitably results as a source of distress. Is therefore necessary to provide also the recorder with a mute allowing practice without disturbing people in the neighbourhood.

A known type of mute for a recorder, which comprises a hollow main body with a mouthpiece forming a channel for the passage of blown air, comprises permeable muting means that are movable between a retracted position, permitting free air flow through the channel, and an effective position, partially blocking the channel. The muting means have a plurality of small passages for restricted air flow there-through.

This kind of mute is not simple to assemble to the recorder. The mute has indeed to be positioned inside the mouthpiece in a specific position not simple to be found, for example, by a child.

### DISCLOSURE OF INVENTION

It is an object of the present invention to provide a mute which permits to soften the timbre and the intensity of the sound even though maintaining the intonation. In particular, it is an object of the invention to provide a reliable, efficient and economically advantageous mute for a recorder. It is also an object of the present invention to provide a mute that is simple to assemble to a recorder even by a child.

According to the present invention there is provided a mute for a recorder; the recorder comprising a window partially delimited by a sharp edge suitable to create air vortexes when invested by blown air; the mute being characterised by comprising a flow barrier inserted through the window so as to partially deviate the air flowing towards the sharp edge.

The mute according to the invention is advantageously adjustable, so as to allow the selection of the degree of softening of the sound of the recorder according to need. The mute, when in the position of maximum softening, allows to play the recorder also during the evening without disturbing the neighbourhood.

Moreover, the mute is very useful when it is necessary to clean the recorder. In fact, when an excess of saliva is formed in the recorder it is necessary to blow hard to clean it, unavoidably emitting a distressing whistle. With the mute mounted, even blowing very hard, no distressing whistle will be emitted.

Finally, the mute according to the present invention can be simply attached and removed from the recorder and is applicable to all of the commercially available recorders.

### BRIEF DESCRIPTION OF THE DRAWINGS

A non-limiting embodiment of the present invention will be described by way of an example with reference to the accompanying drawings, in which:

FIG. 1A shows a schematic front view, with parts removed for clarity, of a mute for a recorder in accordance with the present invention;

FIG. 1B shows a schematic side view, with parts removed for clarity, of the mute of FIG. 1A;

FIG. 2 is a schematic side view, with parts in section and parts removed for clarity, of the mute of FIG. 1A in a assembling step to the recorder; and

FIGS. 3 and 4 are schematic side views, with parts in section and parts removed for clarity, of the mute of FIG. 1A in two respective operating positions with respect of the recorder.

### BEST MODE FOR CARRYING OUT THE INVENTION

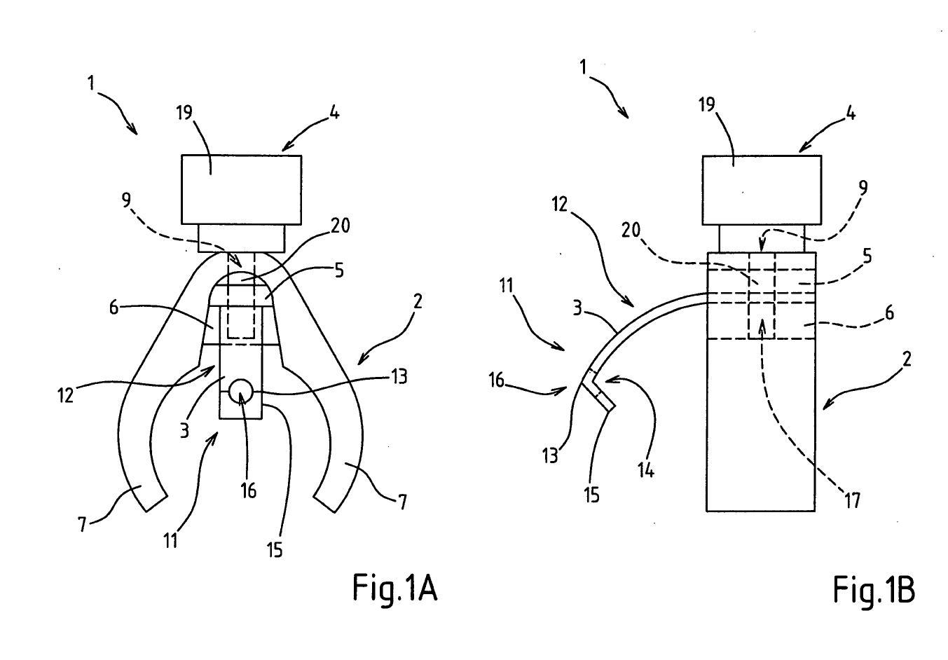

Number 1 in FIG. 1A indicates a mute comprising a clip 2, a leaf 3, a hand-wheel 4, a wedge shaped-element 5, and a nut 6.

The clip 2 is preferably made of flexible material, generally plastic, supports the leaf 3 and is easily attachable and removable from the recorder 22 (FIG. 4) by a slight pressure. The clip 2 comprises two arms 7 which are connected each other and are suitable to clamp a main body 23 of the recorder 22 (FIG. 4). The clip 2 comprises also an aperture 9 which is arranged in the proximity of the point of connection of the two arms 7.

With reference to FIG. 1B, the leaf 3 comprises a first portion 11, comprising a bending 13 forming a corner 14 that subtends a slightly obtuse angle, and a second portion 12 which is curved.

The first portion 11 comprises a first through hole 16 substantially arranged at the corner 14 and an end fin 15. The first through hole 16 is preferably circular and has a diameter of few millimetres (better visible in FIG. 1A).

The second portion 12 of leaf 3 is provided with a second through hole 17.

The leaf 3 is made of an appropriate material, e.g. stainless steel, aluminium, metal alloy, as well as nylon or similar products, and has a thickness of about 0.7-0.8 millimetres and a width of approximately 9 millimetres. The selection of the dimensions of the leaf 3 depends mainly on the material of the leaf 3.

The hand-wheel 4 has the dual purpose of clamping the leaf 3 and of slightly opening the arms 7 of the clip 2 in order to facilitate the mounting on recorders of different sizes.

The hand-wheel 4 comprises a head 19 and a screw 20. The screw 20 is inserted through the aperture 9 of the clip 2, the wedge shaped-element 5, the second through hole 17 of the leaf 3, and finally through the nut 6.

The nut 6 is internally threaded so that the screw 20 entails a strain on the leaf 3 and then on the wedge shaped-element 5, which acts on the angled inner surface of the clip 2 thus opening arms 7.

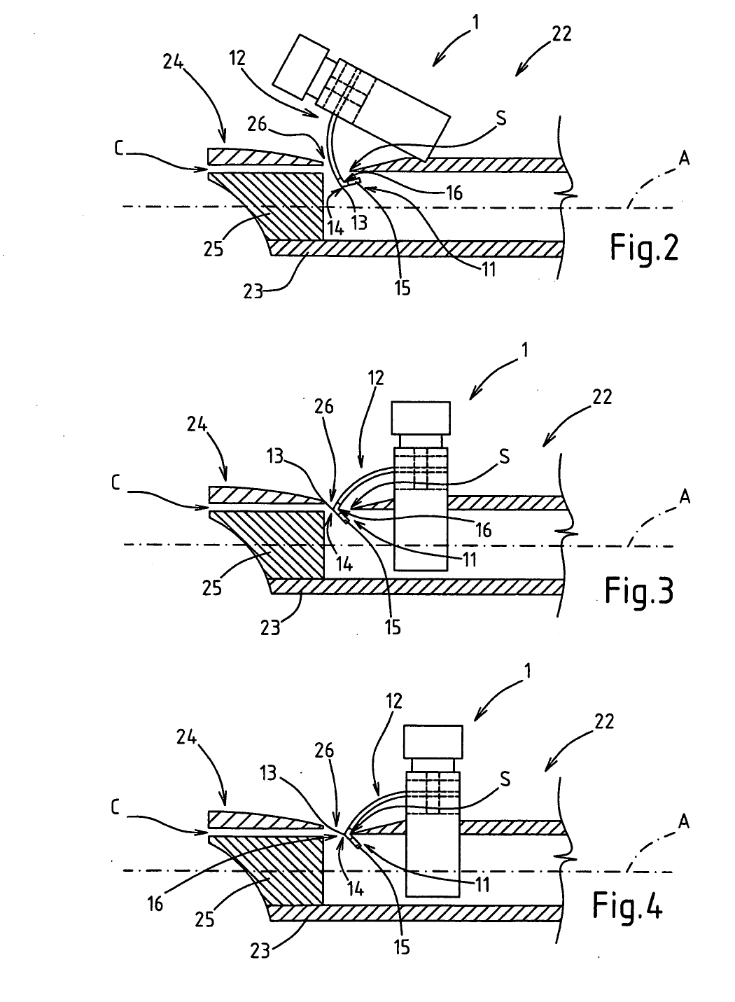

FIG. 2 shows a first step of assembling of the mute 1 to a recorder 22.

The recorder 22 comprises a hollow main body 23 which extends along a longitudinal axis A and comprises one end, called mouthpiece 24, in which the user blows, a block 25, a window 26 and a plurality of circular holes (not shown for simplicity). The block 25 is arranged inside the hollow main body 23 next to the mouthpiece 24 and defines a channel C. The window 26 is proximal to the mouthpiece 24 and is partially delimited by a sharp edge S, which is distal with respect to the mouthpiece 24 and faces the exit of the channel C and is defined by a wall having a decreasing thickness towards the window 26. The sharp edge S is one of the most important parts of the recorder 22 and therefore care have to be taken during the mounting of the mute 1 on the recorder 22.

In fact, in use the blown air normally exits from channel C of the recorder 22 and is directed against the sharp edge S that serves as an air vortexes generator. These vortexes are then transferred inside the hollow main body 23 of the recorder 22, giving rise to sounds that are further modulated by the musician's fingers which selectively close and open the circular holes (not shown for simplicity) positioned along the hollow main body 23.

As shown in FIG. 2, the first portion 11 of the leaf 3 is inserted inside the hollow main body 23 through the window 26 substantially in the middle of the window 26 in order to avoid contact and scraping of the leaf 3 and of the sharp edge S in such a manner that the first through hole 16 faces the sharp edge S.

As shown in FIG. 3, the clip 2 is lowered in such a manner that the arms 7 clamp the hollow main body 23 of the recorder 22.

As shown in FIG. 4, by sliding the mute 1 for few millimetres in a direction parallel to the axis A forward the sharp edge S of the window 26, the mute 1 will stop in a first position, where the corner 14 of the leaf 3 lies near the sharp edge S. In this first position the first portion 11 of the leaf 3, being positioned substantially before the sharp edge S, creates the effect of a flow barrier which partially deviate the blown air coming from the channel C, thereby reducing the air impinging on the sharp edge S and the air vortexes generated and, therefore, the sound of the recorder 22.

In order to achieve the silenced effect the first through hole 16 must be aligned to the sharp edge S in a direction parallel to axis A so that the small part of the blown air passing through the first through hole 16 may in any case be cut by the sharp edge S and may form the air vortexes giving rise to the sound. The adjusting of the right position of the first through hole 16 with respect to the sharp edge S, can be achieved by selecting the appropriate curvatures of the leaf 3. A first part of the blown air which does not pass through the first through hole 16 is deviated by the end fin 15 into the hollow main body 23; while a second part of the blown air which does not pass through the first through hole 16 is deviated by the curved second portion 12 out of the hollow main body 23 of the recorder 22.

The mute 1 is advantageously adjustable to obtain different degrees of softening of the sound of the recorder 22. The mute 1 is indeed selectively movable along the hollow main body 23 in several positions to obtain different degrees of sound softening effect. In a first position, the corner 14 is very close to the sharp edge S of the window 26 of the recorder 22 giving rise to soft and clear sounds; in other positions, the more the corner 14 is spaced apart from the sharp edge S of the window 26, the more the mute 1 gives rise to soft and toneless sounds.

The shift of the mute 1 is simply obtained by sliding the clip 2 for few millimetres in a direction parallel to the axis A of the recorder 22. Gradually moving the mute 1 from the main position to the other positions the sounds are gradually softer and more “toneless” because the flow barrier effect is greater.

Similarly at the assembling, the removing of the mute 1 from the recorder 22, not shown in the enclosed figures for simplicity, needs to displace the corner 14 of the leaf 3 away from the sharp edge S by simply sliding the mute 1 in a direction parallel to the axis A. Then, a simple rotation of the clip 2 entails the detachment of the mute 1 from the recorder 22.

The only elements of the mute 1 in contact with the recorder 22 are the arms 7 of the clip 2, which will entail a slight pressure, which is, by the way, also previously adjusted by the blocking hand-wheel 4, so that there will be a minimal friction not capable of damaging the outer surface of the recorder 22.

The invention conceived in this way is liable to many modifications and variations, especially as materials and size are concerned, all of which are included in the scope of the inventive concept.

1. Mute for a recorder; the recorder comprising a window partially delimited by a sharp edge (S) suitable to create air vortexes when invested by blown air; the mute being characterised by comprising a flow barrier inserted through the window so as to partially deviate the blown air flowing towards the sharp edge (S).

2. Mute as claimed in claim 1, characterised in that the flow barrier is a leaf partially inserted through the window.

3. Mute as claimed in claim 2, characterised in that the leaf is provided with a first through hole facing the sharp edge (S).

4. Mute as claimed in claim 3, characterised in that the leaf comprises a bending, forming a corner; said first through hole being arranged at the corner.

5. Mute as claimed in claim 4, characterised in that the bending is shaped in such a manner to deviate a part of the blown air, not passing through the first through hole, respectively into the hollow main body and out of the hollow main body of the recorder.

6. Mute as claimed in claim 4, characterised in that the corner subtends a slightly obtuse angle.

7. Mute as claimed in claim 1, characterised in that it comprises a support element which supports the flow barrier; the support element being connected to the recorder.

8. Mute as claimed in claim 6, characterised in that the support element is connected in a fixed way to the recorder.

9. Mute as claimed in claim 6, characterised in that the support element is a clip.

10. Mute as claimed in claim 8, characterised in that the clip comprises two arms, connected each other and suitable to clamp the recorder, and an aperture arranged in the proximity of the point of connection of the two arms.

11. Mute as claimed in claim 8, characterised in that the clip is made of plastic material.

12. Mute as claimed in claim 2, characterised in that the leaf comprises a second through hole.

13. Mute as claimed in claim 2, characterised in that the leaf is made of metallic material, e.g. stainless steel, aluminium, metal alloy.

14. Mute as claimed in claim 2, characterised in that the leaf is made of nylon or similar products.

15. Mute as claimed in claim 6, characterised by comprising means of connecting the support element with the flow barrier.

16. Mute as claimed in claim 14, characterised in that the connecting means comprise a wedge shaped-element, a nut internally threaded, and a hand-wheel which comprises a head and a screw.

17. Mute as claimed in claim 9, characterised in that the screw is inserted through the aperture of the clip, the wedge shaped-element, the second through hole of the leaf and the nut in such a way that the screwing of the hand-wheel entails a strain on the leaf and then on the wedge shaped-element, which acts on the angled inner surface of the clip thus opening arms.

18. Mute as claimed in claim 1, characterised in that the mute is selectively movable along the recorder in several positions to obtain different degrees of sound softening effect.

19. Mute as claimed in claim 4, characterised in that the mute is selectively movable along the recorder in several positions to obtain different degrees of sound softening effect; in a first position the corner is very close to the sharp edge S of the window the recorder giving rise to soft and clear sounds; in other positions, the corner is spaced from the sharp edge S of the window giving rise to more and more soft and toneless sounds.

20. A recorder, comprising a window partially delimited by a sharp edge (S) suitable to create air vortexes when invested by blown air, and a mute; the recorder being characterised by the fact that the mute Comprises a flow barrier inserted through the window so as to partially deviate the blown air flowing towards the sharp edge (S).

21. A combination of a recorder and a mute; the recorder comprising a window partially delimited by a sharp edge (S) suitable to create air vortexes when invested by blown air; the combination being characterised by the fact that the mute comprises a flow barrier inserted through the window so as to partially deviate the blown air flowing towards the sharp edge (S).
